(19) United States
(12) Patent Application Publication
(10) Pub. No.: US 2020/0228465 A1
(43) Pub. Date: Jul. 16, 2020

(54) SWITCH FOR AN AVIONICS COMMUNICATION SYSTEM AND AVIONICS COMMUNICATION SYSTEM COMPRISING SUCH A SWITCH

(71) Applicant: THALES, Courbevoie (FR)

(72) Inventors: Eric Fitterer, Merignac (FR); Stéphane Monnier, Merignac (FR); Arnaud Sitbon, Merignac (FR); Alain Dugas, Merignac (FR)

(21) Appl. No.: 16/723,696

(22) Filed: Dec. 20, 2019

(30) Foreign Application Priority Data
Dec. 26, 2018 (FR) FR 18 74165

(51) Int. Cl. H04L 12/931; H04L 12/937; H04L 12/781; H04L 12/927

(52) U.S. Cl. CPC H04L 49/602; H04L 49/351; H04L 47/805; H04L 45/52; H04L 49/254

(57) ABSTRACT

The present invention relates to a switch comprising a plurality of input ports, a plurality of output ports, and a first routing component that is capable of routing each frame of a first type in compliance with a first protocol between at least one input port and one output port associated with this component.

The switch in addition comprises a second routing component capable of routing each frame of a second type in compliance with a second protocol between at least one input port and one output port associated with this component, and an allocation interface capable of associating each input port and each output port with the first routing component or with the second routing component, in accordance with a predetermined configuration.

### CROSS-REFERENCE TO RELATED APPLICATIONS

This application is a U.S. non-provisional application claiming the benefit of French Application No. 18 74165, filed on Dec. 26, 2018, which is incorporated herein by reference in its entirety.

### FIELD OF THE INVENTION

The present invention relates to a switch for an avionics communication system.

The present invention also relates to an avionics communication system comprising such a switch.

The invention makes it possible in particular to set up and deploy a mixed avionics communication system which operationally implements at the same time two or more avionic networks that are to operate in a segregated manner.

In particular, two avionic networks operating in a segregated manner preclude any physical interaction between the frames transmitted via these networks.

### BACKGROUND

In a manner known per se, in an aircraft, avionics networks that are referred to as closed world networks, are segregated from avionic networks that are referred to as open world networks.

Among the closed world networks, in particular avionics networks that are compliant with the ARINC 664 standard are already known.

In a manner known per se, the ARINC 664 standard is based on the Ethernet standard and it provides the means in particular to adapt the use of this standard to the avionics context and notably, to the related avionics constraints.

The ARINC 664 standard is made up of a number of parts, with each part being usable in accordance with the constraints imposed on the data passing through the avionics network that is operationally implemented on the basis of this standard.

Among these various parts, in particular the part referenced as “P7” and generally denoted by “ARINC 664 P7” or “ARINC 664 Part 7” or even “AFDX 6”, is generally known.

This part P7 can be used to transmit avionics data between different avionics systems that are operationally implementing the essential functions of the aircraft and thus presents the greatest number of constraints.

Thus, an avionics network implemented on the basis of part P7 presents a segregated, redundant and deterministic network. The determinism of this network signifies in particular that each frame transmitted reaches its destination within a known maximum timeframe.

In some avionics networks, it is also possible to use the Ethernet protocol (within the meaning and for the purposes of the IEEE 802.3-2000 standard and subsequent versions) combined with a certain number of additional restrictions imposed by the nature of the corresponding network.

As compared to the part P7 of the ARINC 664 standard, the Ethernet protocol with related restrictions presents fewer constraints and can therefore be used for operationally implementing avionic networks that transmit less sensitive and or less critical data.

This data generally represent data and information pertaining to maintenance, download and crew service functions relating to different avionics systems. Thus, in the event of loss of these data, they may be retransmitted again without generating considerable risk for the safety of the aircraft.

The additional restrictions imposed on the Ethernet protocol may notably pertain to the manner in which the frames are routed. Thus, for example, this routing may be predetermined within each switch of the network, in accordance with the identifier of the frame.

This is for example the case of the part referenced as “P3” of the ARINC 664 standard which is also based on the Ethernet protocol but which presents fewer constraints in comparison with the part P7 and however recommends a network usage mode that is configured statically for an operational mode on the aircraft.

The aforementioned avionics networks are the said to be closed world networks insofar as on board an aircraft, they are physically segregated from all other avionics networks. This then ensures the effective protection thereof from any outside influence.

Currently, an increasing number of open world data networks, that is to say data networks accessible from the exterior are present on board an aircraft.

This is so for example in the case of a passenger entertainment network or any other network that can be used for the transmission of non-avionics data.

These networks are generally implemented in compliance with the conventional Ethernet protocol on the basis of which the data frames passing through the network are generally routed by means of a mechanism that relies on self-learning, that is to say according to the manner considered most appropriate based on the routing tasks performed previously.

These networks are therefore segregated from the avionics networks that are compliant with the ARINC 664 standard in order to prevent any interaction between frames that differ in nature.

It is also possible that within an aircraft there may be avionics networks that are of the same kind, that is to say open world or closed world networks, which nevertheless must be segregated from each other.

Thus, for example, it is possible to have two networks of the ARINC 664 P7 type or two networks of the conventional Ethernet type, which must be segregated from one another.

In all of the examples cited above, so as to ensure the necessary segregation, it is usual to use different physical means in order to operationally implement the corresponding networks.

This entails in particular the use of switches and transmission means that are physically different.

It is therefore clearly conceivable that this type of segregation involves at least a doubling of each physical component operationally implementing these networks. This thus then involves many problems in terms of dimensional and space requirements and weight in a structure hosting these networks such as an aircraft.

### SUMMARY

The object of the present invention is therefore to solve these problems and thus to provide a communication system that makes it possible to ensure the sharing of at least certain physical components for avionic networks which need to be segregated.

To this end, the object of the invention relates to a switch for an avionics communication system that transmits digital data in the form of frames of a first type that are in compliance with a first protocol and frames of a second type that are in compliance with a second protocol which is different from the first protocol, with the frames of different types being transmitted in a segregated manner, the switch comprising:
a plurality of input ports, each input port being capable of receiving frames of each type originating from an equipment unit or from another switch;
a plurality of output ports, each output port being capable of transmitting the frames of each type to an equipment unit or another switch;
a first routing component capable of routing each frame of the first type in compliance with the first protocol between at least one input port and one output port associated with this component;

the switch in addition comprises:
a second routing component capable of routing each frame of the second type in compliance with the second protocol between at least one input port and one output port associated with this component;
an allocation interface capable of associating each input port and each output port with the first routing component or with the second routing component, in accordance with a predetermined configuration.

According to other advantageous aspects of the invention, the switch comprises one or more of the following characteristic features, taken into consideration alone or in accordance with any technically possible combination:
it is configured so as to operate according to an operational mode of operation in which the predetermined configuration cannot be modified and according to a maintenance mode of operation in which the predetermined configuration can be modified;
the predetermined configuration is determined according to the position of the switch;
each of the first routing component and the second routing component is in the form of a routing matrix;
each of the first protocol and the second protocol is of the Ethernet type;
defining the same physical layer for the first protocol and the second protocol, the allocation interface being capable of associating each input port and each output port with the first routing component or with the second routing component at the said physical layer;
the first protocol is a protocol of type Ethernet with predetermined routing;
the first protocol is a protocol of type ARINC 664 P7;
the first protocol is a mixed protocol composed of a protocol of type ARINC 664 P7 and a protocol of type Ethernet with predetermined routing;
the first routing component is capable of differentiating the data frames conforming to the ARINC 664 P7 type protocol and the data frames conforming to the Ethernet type protocol with predetermined routing, and of processing each data frame in compliance with the corresponding protocol, each data frame conforming to the ARINC 664 P7 type protocol being processed on a prioritized basis in relation to each data frame conforming to the Ethernet type protocol with predetermined routing; and
at least one input port or output port is associated directly with the first routing component or with the second routing component in a fixed manner, without needing the intervention of the allocation interface.

The object of the invention also relates to a communication system for avionics communication comprising:
a plurality of switches connected to each other in order to form a data network;
a plurality of equipment units, each equipment unit being a transmitter and or receiver of digital data and being connected to at least one switch;

the digital data being present in the form of frames of the first type that are in compliance with a first protocol and frames of the second type that are in compliance with a second protocol, the frames of different types being transmitted in a segregated manner;

at least one of the switches is a conforming switch as described here above.

### BRIEF DESCRIPTION OF THE DRAWINGS

These features and advantages of the invention will become apparent upon reading the description which follows, provided solely by way of non-limiting example, and with reference made to the appended diagrams, in which:

FIG. 1 is a schematic view of an aircraft comprising two segregated avionics networks;

FIG. 2 is a schematic view of a communication system according to the invention, the communication system operationally implementing the networks shown in FIG. 1 and including at least one switch according to the invention; and

FIG. 3 is a detailed schematic view of the switch shown in FIG. 2.

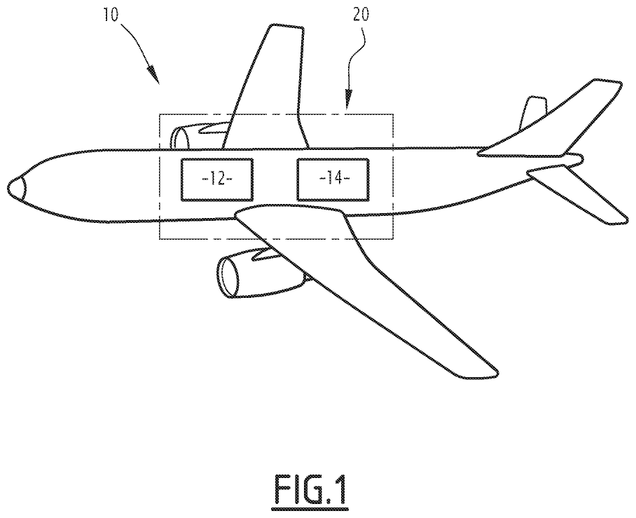

In all the following sections, any mention of a standard, in particular of an ICT standard, makes reference to the general principles of this standard which are well known to the person skilled in the art and which are independent of different versions of this standard, unless expressly stated otherwise. FIG. 1 illustrates an aircraft 10 such as an airplane.

The aircraft 10 comprises a first avionics network 12 and a second avionics network 14 that are segregated from each other.

In particular, the term “segregation of avionics networks” is understood to refer to the set of properties of these networks that make it possible to preclude any interaction between the digital data transmitted by these different networks.

According to one particular example of the embodiment of the invention described in the following section/s, the first avionics network 12 provides the means to transmit sensitive data between different avionics systems. The term “sensitive data” is used to refer in particular to any data whose loss or delay in transmission can have an influence on the safety of the aircraft 10. These sensitive data must therefore be segregated from all other types of data.

In particular, the first avionics network 12 provides the means to transmit data frames in compliance with a first transmission protocol. These frames therefore conform to this first protocol and shall be subsequently referred to by the term “frames of the first type”.

This first protocol is for example of the type Ethernet (within the meaning and for the purposes of the IEEE 802.3-2000 standard and subsequent versions) with predetermined routing.

In all the following sections, the term ‘predetermined routing’, is understood to refer to a routing mode based on which each frame is routed in the network according to predetermined rules.

These predetermined rules are in particular saved and stored in a configuration table of each switch that operationally implements the first avionics network 12 and they define the routing of each frame within this switch.

Thus, for example, this is the case when the configuration table of each switch defines for each frame an input port and one or more output ports, or when the configuration table of each switch defines for each frame one or more output ports.

According to a first embodiment of the invention, the first protocol is of the type ARINC 664 P7 or of the type ARINC 664 P3.

In the example described, the second avionics network 14 provides the means to transmit data frames that are not sensitive in compliance with a second transmission protocol. These frames therefore conform to this second protocol and shall be subsequently referred to by the term “frames of the second type”.

This second protocol is for example of the type Ethernet (within the meaning and for the purposes of the IEEE 802.3-2000 standard and subsequent versions).

In particular, in contrast to the first protocol, the second protocol does not impose predetermined routing rules. Such routing is for example based on the self-learning feature of the network, that is to say according to the manner considered most appropriate based on the routing tasks performed previously.

According to the invention, the avionic networks 12 and 14 are operationally implemented by the same physical avionics communication system 20 while also making possible the segregation of the frames of the first type and of the second type.

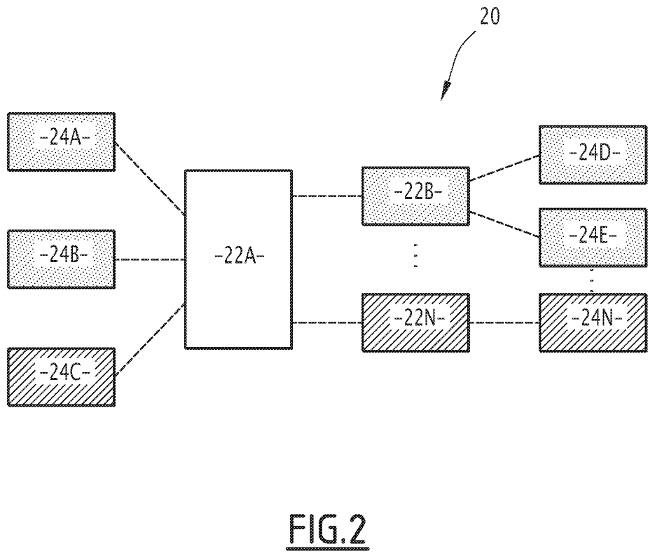

An example of such an avionics communication system 20 is illustrated in FIG. 2.

Thus, with reference to this figure, this communication system 20 comprises a plurality of switches 22A, . . . , 22N and a plurality of equipment units 24A, . . . , 24N.

Each equipment unit 24A, . . . , 24N, also known by the commonly accepted term “End System”, is integrated into an on-board system and serves to ensure the communication between this system and one of the networks 12, 14.

Thus, depending on the on-board system within which it is integrated, each equipment unit 24A, . . . , 24N can be a transmitter and/or receiver of frames of the first type or of frames of the second type.

In particular, in the example shown in FIG. 2, the equipment units 24A, 24B, 24D and 24E provide the means to transmit and/or receive frames of the first type intended to be sent to the first avionics network 12 or originating from this network 12.

In the same example, the equipment units 24C and 24N provide the means to transmit and/or receive frames of the second type intended to be sent to the second avionics network 14 or originating from this network 14.

Each equipment unit 24A, . . . , 24N is connected to at least one of the switches 22A, . . . 22N via the transmission means and via at least one port of this switch.

The transmission means present for example a twisted pair cable or any other type of cable that serves to enable bidirectional transmission of data.

Each switch 22A, . . . 22N comprises a plurality of input and output ports and makes it possible to route each incoming frame via an input port to an output port.

In addition, when the protocols of the two avionic networks 12, 14 are of the Ethernet type, each switch 22A, . . . 22N is in compliance with the IEEE 802.1D standard.

In the example shown in FIG. 2, the switch 22B is dedicated to the first avionics network 12. In other words, this switch 22B makes it possible to route only the frames of the first type according to a predetermined configuration table therein.

Furthermore, in the same example, the switch 22N is dedicated to the second avionics network 14. In other words, this switch 22N makes it possible to route only frames of the second type.

The switches 22B to 22N are known per se and shall not be explained in detail in the following sections.

According to the invention, at least one of the switches 22A, . . . , 22N of the system 20 is of the mixed type insofar as it provides the ability to route frames of different types while also ensuring the segregation of these frames.

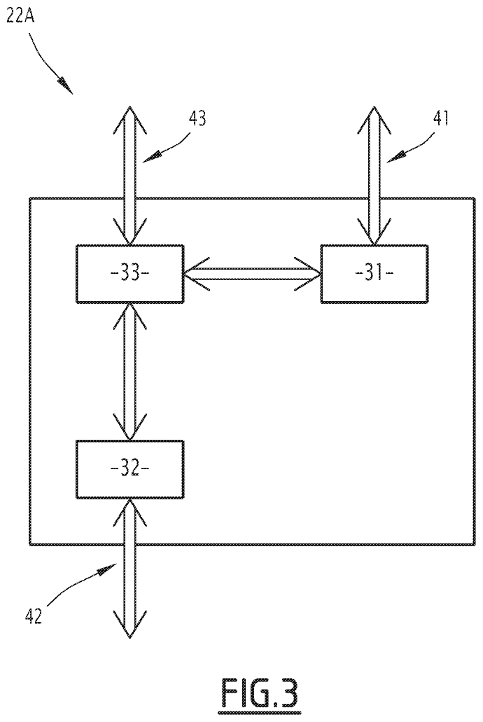

In the example shown in FIG. 2, the switch 22A is of the mixed type. Its structure will be explained in detail in the following sections with reference to FIG. 3.

Thus, as can be seen in FIG. 3, the switch 22A comprises a first routing component 31, a second routing component 32 and an allocation interface 33.

The first routing component 31 is for example in the form of a routing matrix and is able to route each frame of the first type between at least one input port and one output port associated with this component.

In an analogous manner, the second routing component 32 is for example in the form of a routing matrix and able to route each frame of the second type between at least one input port and one output port associated with this component.

According to the invention, the allocation interface 33 makes it possible to associate each input port and each output port of the switch 22A with the first routing component 31 or with the second routing component 32, in accordance with a predetermined configuration.

Furthermore, when the protocols of the two avionics networks 12, 14 are of the Ethernet type, the allocation interface 33 provides the means to effect the corresponding association of each input port and each output port at the physical layer defined by this switch 22A.

In all cases, the association of the ports is carried out at the lowest level of frame management defined by the switch 22A.

In addition, the switch 22A is configured so as to operate in an operational mode of operation and in a maintenance mode of operation.

In the operational mode of operation, the predetermined configuration of the allocation interface 33 cannot be modified.

The operational mode of operation is effectively implemented during the normal operation of the communication system 20.

In the maintenance mode of operation, the predetermined configuration of the allocation interface 33 can be modified. The maintenance mode of operation is executed for example at the start-up of the communication system 20 or indeed upstream therefrom, at the development of the latter.

Thus, during this maintenance mode of operation, a predetermined configuration of the allocation interface is for example defined by an external system that is independent of the communication system 20, depending for example on the location of the switch 22A within the aircraft.

This predetermined configuration is for example transmitted to the switch 22A via a port dedicated to the configuration.

In order to associate a port with one of the routing components, the predetermined configuration presents for example a table comprising for the identifier of each input and output port of the switch 22A an indication relating to the first routing component 31 or to the second routing component 32. On the basis of this indication, the allocation interface is therefore able to associate each port of the switch 22A with the first routing component 31 or with the second routing component 32.

Thus, in the operational mode of operation of the switch 22A, upon reception of a frame via an input port, the allocation interface 33 transmits this frame directly to the routing component with which this input port is associated.

Upon the transmission of a frame by one of the routing components 31, 32, the allocation interface 33 transmits this frame directly to one of the output ports associated with this component.

Advantageously, the switch 22A in addition comprises at least one input port or output port that is directly associated with one of the routing components 31, 32 in a fixed manner, without needing the intervention of the allocation interface 33.

Thus, in the example shown in FIG. 3, the arrow 41 is used to denote all of the input and/or output ports associated in a fixed manner with the first routing component 31, the arrow 42 is used to denote all of the input and/or output ports associated in a fixed manner with the second routing component 32, and the arrow 43 is used to denote all of the ports that may possibly be associated with one of these components 31, 32 via the allocation interface 33 in accordance with the predetermined configuration of the latter.

In addition, with regard to the example in FIG. 2, the arrow 41 is used to denote the port connecting the switch 22A to the switch 22BA, the arrow 42 is used to denote the port connecting the switch 22A to the switch 22N, and the arrow 43 is used to denote the ports connecting switch 22A to the equipment units 24A, 24B and 24C.

Each of the first routing component 31, the second routing component 32, and the allocation interface 33 is for example present in the form of a programmable logic circuit of type FPGA (abbreviation for the term “Field-Programmable Gate Array”) or ASIC (abbreviation for the term “Application Specific Integrated Circuit”).

Furthermore, the routing components 31, 32 are physically segregated from one another, thus precluding any physical interaction between frames of different types.

In addition, advantageously, the first routing component 31 and the allocation interface 33 form a single physical component. Still more advantageously, the second routing component 32 is a component of the type COTS (abbreviation for the term “Commercial off-the-shelf”), that is to say a component of the type available to be “sold off the shelf”. In this case, it is connected to the allocation interface 33 by means of an appropriate bus.

It can therefore be seen that the invention makes it possible to operationally implement two segregated avionics networks within the same communication system.

The invention makes it possible in fact to use the same switch in order to transmit data that differ in nature from each other with this being achieved while also maintaining intact the segregation of this data. This is achieved by using a predetermined configuration for association of the ports with the different routing components. This association is effected at the lowest level of the switch, that is to say at the physical level, which makes it possible to ensure the segregation of data within the same switch.

In addition, this configuration can only be modified in a specific mode of operation, referred to as maintenance mode of operation. This then provides the means to ensure the necessary security during the operation of the communication system 20.

Finally, even if the example given above is described in relation to two avionics networks that differ in nature from each other, the invention remains applicable to any two avionics networks that need to be segregated. Thus, for example, it is possible to apply the invention to two avionic networks that are compliant with the ARINC 664 P7 standard or with the Ethernet standard.

In addition, it is clear that the invention can be applied to a number N that is greater than 2 of avionic networks.

The avionic communication system according to a second embodiment of the invention will now be explained.

This communication system is substantially analogous to the system according to the first embodiment and in particular comprises the same components. These components will therefore be denoted by the same reference numerals as in the previous case.

In contrast to the first embodiment, the first protocol used in the communication system 20 according to the second embodiment presents a mixed protocol composed of a third protocol and a fourth protocol.

The third protocol is of the type ARINC 664 P7.

The fourth protocol is of the type Ethernet with predetermined routing. This fourth protocol is for example of the type ARINC 664 P3.

Thus, in order to operationally implement the transmission of frames according to such a mixed protocol, the first routing component 31 of the switch 22A and the switch 22B dedicated to the avionics network 12 are modified as compared to the preceding case.

In particular, these elements are modified so as to differentiate each incoming frame based on the protocol thereof and to process this frame in accordance therewith.

In addition, each frame conforming to the third protocol, that is to say to the protocol of type ARINC 664 P7, is processed on a prioritized basis in relation to each frame conforming to the fourth protocol.

The differentiation of the frames according to the third protocol and according to the fourth protocol is carried out based on a header of these frames.

Thus, for example, the first bytes of the header of each frame conforming to the fourth protocol is defined by any value that is other than/different from the value “0000 0011 0000 0000 0000 0000 0000 0000 0000”. It is in fact known that this value is reserved for each frame conforming to the protocol of type ARINC 664 P7 in a field of its header known as “MAC DEST”.

It is clear that in this embodiment, the second routing component 32 as well as the allocation interface 33 remain unchanged, which thus continues to enable the segregating of the second avionics network 14 from the first avionics network 12.

The invention according to the second embodiment therefore makes it possible to implement operational conditions enabling the mixing—“mixability”—of different avionics networks while also maintaining intact the segregation thereof from another avionics network. It is therefore possible to operationally implement all of these avionics networks using the same switches, which serves the purpose of further reducing the dimensional footprint and the weight of the avionic communication system according to the invention.

1. A switch for an avionics communication system that transmits digital data in the form of frames of a first type that are in compliance with a first protocol and frames of a second type that are in compliance with a second protocol which is different from the first protocol, with the frames of different types being transmitted in a segregated manner, the switch comprising:
a plurality of input ports, each input port being capable of receiving frames of each type originating from an equipment unit or from another switch;
a plurality of output ports, each output port being capable of transmitting the frames of each type to an equipment unit or another switch;
a first routing component capable of routing each frame of the first type in compliance with the first protocol between at least one input port and one output port associated with this component;
a second routing component capable of routing each frame of the second type in compliance with the second protocol between at least one input port and one output port associated with this component; and
an allocation interface capable of associating each input port and each output port with the first routing component or with the second routing component, in accordance with a predetermined configuration.

2. The switch according to claim 1, configured so as to operate according to an operational mode of operation in which the predetermined configuration cannot be modified and according to a maintenance mode of operation in which the predetermined configuration can be modified.

3. The switch according to claim 1, in which the predetermined configuration is determined according to the position of the switch.

4. The switch according to claim 1, in which each of the first routing component and the second routing component is in the form of a routing matrix.

5. The switch according to claim 1, in which each of the first protocol and of the second protocol is of the Ethernet type.

6. The switch according to claim 5, defining a same physical layer for the first protocol and the second protocol, the allocation interface being capable of associating each input port and each output port with the first routing component or with the second routing component at the said physical layer.

7. The switch according to claim 1, in which the first protocol is a protocol of type Ethernet with predetermined routing.

8. The switch according to claim 7, in which the first protocol is a protocol of type ARINC 664 P7.

9. The switch according to claim 7, in which the first protocol is a mixed protocol composed of a protocol of type ARINC 664 P7 and a protocol of type Ethernet with predetermined routing;
and in which the first routing component is capable of differentiating the data frames conforming to the ARINC 664 P7 type protocol and the data frames conforming to the Ethernet type protocol with predetermined routing, and of processing each data frame in compliance with the corresponding protocol, each data frame conforming to the ARINC 664 P7 type protocol being processed on a prioritized basis in relation to each data frame conforming to the Ethernet type protocol with predetermined routing.

10. The switch according to claim 1, in addition comprising at least one input or output port associated directly with the first routing component or with the second routing component in a fixed manner, without needing the intervention of the allocation interface.

11. An avionics communication system comprising:
a plurality of switches connected to each other in order to form a data network;
a plurality of equipment units, each equipment unit being a transmitter and or receiver of digital data and being connected to at least one switch;
the digital data being present in the form of frames of the first type that are in compliance with a first protocol and frames of the second type that are in compliance with a second protocol, the frames of different types being transmitted in a segregated manner;
wherein at least one of the switches conforms to claim 1.
